(19) United States
(12) Patent Application Publication
(10) Pub. No.: US 2023/0294992 A1
(43) Pub. Date: Sep. 21, 2023

(54) TRISILYLAMINE PREPARATION APPARATUS AND PREPARATION METHOD

(71) Applicant: SK Specialty Co., Ltd., Yeongju-si, Gyeongsangbuk-do (KR)

(72) Inventors: Yoonsik LEE, Yeongju-si, Gyeongsangbuk-do (KR); Soojin KIM, Yeongju-si, Gyeongsangbuk-do (KR); Sambong KWON, Yeongju-si, Gyeongsangbuk-do (KR); Jaeseong PARK, Yeongju-si, Gyeongsangbuk-do (KR); Taesoon KIM, Yeongju-si, Gyeongsangbuk-do (KR)

(73) Assignee: SK Specialty Co., Ltd., Yeongju-si, Gyeongsangbuk-do (KR)

(21) Appl. No.: 18/019,021

(22) PCT Filed: Jul. 27, 2021
(86) PCT No.: PCT/KR2021/009728

§ 371 Date: Jan. 31, 2023

(30) Foreign Application Priority Data
Aug. 21, 2020 (KR) 10-2020-0105588

(51) Int. Cl. C01B 21/068; B01J 8/02; B01J 6/00

(52) U.S. Cl. CPC C01B 21/068; B01J 8/0285; B01J 6/008; B01J 2208/00026; B01J 2208/00761

(57) ABSTRACT

A trisilylamine preparation apparatus includes: a reactor in which a trisilylamine synthesis reaction occurs; a reactant supply pipe for supplying reactants to the reactor; a trisilylamine discharge pipe for discharging trisilylamine from the reactor; a reactor heating means for heating the reaction space of the reactor; and a gaseous by-product discharge pipe for discharging a gaseous by-product from the reactor. The reaction space of the reactor is maintained at a temperature that is lower than the decomposition temperature of a reaction by-product generated during the synthesis reaction, the reactor heating means heats the reaction space of the reactor to a temperature that is higher than or equal to the decomposition temperature after trisilylamine is discharged through the trisilylamine discharge pipe, and the gaseous by-product discharge pipe discharges a gaseous by-product comprising a pyrolysate of the reaction by-product, generated through pyrolysis by means of the reactor heating means.

### CROSS-REFERENCE TO PRIOR APPLICATIONS

This application is a National Stage patent Application of PCT International Patent Application No. PCT/KR2021/009728 (filed on Jul. 27, 2021) under 35 U.S.C. § 371, which claims priority to Korean Patent Application No. 10-2020-0105588 (filed on Aug. 21, 2020), which are all hereby incorporated by reference in their entirety.

### BACKGROUND

The present invention relates to an apparatus and a method for preparing trisilylamine and, more particularly, to an apparatus and a method for preparing trisilylamine by which solid ammonium chloride (NH₄Cl₂) produced as a reaction by-product in the process of synthesizing trisilylamine can be thermally decomposed in a reactor and removed.

Trisilylamine (TSA, N(SiH₃)₃) is a colorless spontaneous combustible compound having a melting point of −105.6° C. and a boiling point of +52° C., and can be used, for example, in the manufacture of a semiconductor device as a precursor for forming silicon nitride or silicon oxynitride.

Trisilylamine is generally synthesized from monochlorosilane and ammonia according to the following reaction scheme.

3H₃SiCl+4NH₃→N(SiH₃)₃+3NH₄Cl

Ammonium chloride, which is a by-product produced during the synthesis reaction of trisilylamine, acts as a catalyst to decompose trisilylamine into silane and another decomposition product (e.g., silazane), and lowers the yield of trisilylamine.

In addition, ammonium chloride is a solid phase under conventional reaction conditions, resulting in problems such as pipe clogging in the reactor.

In order to prevent pipe clogging due to solid ammonium chloride in the reactor, solid ammonium chloride is periodically removed from the conventional preparation apparatus using a filter and/or a separate removal means, but the solid particles of ammonium chloride collected by the filter and/or the separate removal means may be smeared with flammable silane-based substance (silane, silazane, etc.), which are other by-products of the synthesis reaction, or a trace amount of trisilylamine.

When the solid ammonium chloride collected by the filter or the separate removal means is discarded as it is, the combustible material such as silane smeared on the surface of the solid particles of ammonium chloride is exposed to the atmosphere, which may cause spontaneous ignition.

### SUMMARY

The objective of the present invention is to solve the problems of the conventional technology and to provide an apparatus and a method for preparing trisilylamine which can safely remove solid ammonium chloride in a reactor by pyrolyzing the solid ammonium chloride.

The apparatus for preparing trisilylamine according to an aspect of the present invention comprises: a reactor in which a trisilylamine synthesis reaction occurs; reactant supply pipes for supplying reactants to the reactor; a trisilylamine discharge pipe for discharging trisilylamine from the reactor; a reactor heating means for heating reaction space of the reactor; and a gaseous by-product discharge pipe for discharging gaseous by-products from the reactor, wherein the reaction space of the reactor is maintained at a temperature lower than the decomposition temperature of a reaction by-product produced during the synthesis reaction, and wherein the reactor heating means heats the reaction space of the reactor to a temperature equal to or higher than the decomposition temperature after trisilylamine is discharged through the trisilylamine discharge pipe, and the gaseous by-product discharge pipe discharges the gaseous by-products containing a pyrolysate of the reaction by-product, which is thermally decomposed using the reactor heating means.

The method for preparing trisilylamine according to another aspect of the present invention comprises the steps of: introducing reactants into a reactor; reacting the introduced reactants to produce trisilylamine and a reaction by-product; discharging trisilylamine from the reactor; pyrolyzing the reaction by-product in the reactor, after the trisilylamine discharge step; and discharging gaseous by-products produced in the step of pyrolyzing the reaction by-product from the reactor, wherein, during the step of reacting, the temperature in the reactor is maintained at a temperature lower than the decomposition temperature of the reaction by-product, and wherein the step of pyrolyzing comprises a step of heating the reaction space of the reactor to a temperature equal to or higher than the decomposition temperature of the reaction by-product.

According to the configuration of the present invention, solid ammonium chloride accumulated in the reactor as a by-product of the synthesis reaction of trisilylamine can be safely removed from the trisilylamine preparation apparatus by pyrolysis.

### BRIEF DESCRIPTION OF THE DRAWINGS

FIG. 1 is a schematic view illustrating a preparation apparatus according to Embodiment 1 of the present invention.

FIG. 2 is a schematic view illustrating a preparation apparatus according to Embodiment 2 of the present invention.

### DETAILED DESCRIPTION

Hereinafter, preferred embodiments of the present invention will be described with reference to the drawings. However, the dimensions, materials, shapes of the components of the preparation apparatus, a relative arrangement thereof, a process flow of the preparation method, a reaction condition, and the like may be appropriately changed within the scope of the technical idea of the present invention, and the protection scope of the present invention is not intended to be limited to the embodiments described below.

In the apparatus for preparing trisilylamine according to the present invention, trisilylamine is synthesized according to the following reaction scheme.

3SiH₃X+4NH₃→N(SiH₃)₃+3NH₄X(X═Cl,F,Br)

A reactor of the preparation apparatus according to an embodiment of the present invention is operated under the conditions that ammonium halide, which is a reaction by-product, may stay in the reactor, and a reaction product such as trisilylamine may be discharged to the outside of the reactor without substantially containing ammonium halide and be collected. Ammonium halide in the reactor is separately pyrolyzed in the reactor after the discharge of trisilylamine, to be safely removed.

That is, in one embodiment of the present invention, the synthesis reaction conditions in the reactor is set such that ammonium halide, which is the by-product of the synthesis reaction, is accumulated in the lower portion of the reactor or attached to the side wall of the reactor to stay inside the reactor, and trisilylamine which is the reaction product is phase-separated (e.g., liquid state or gas state) from the ammonium halide which is the reaction by-product. When trisilylamine, which is the reaction product, is obtained in a liquid state, it is separately discharged to the outside of the reactor in a gaseous state by heating and is collected. The solid ammonium halide accumulated in the reactor is decomposed into gaseous ammonia or hydrogen chloride by a separate heating process after discharging the gaseous trisilylamine, and gaseous ammonia and hydrogen chloride are discharged to the outside of the reactor as gaseous by-products along with the silane smeared on the solid particles of ammonium halide to be safely removed.

Hereinafter, specific embodiments of the present invention will be described in more detail.

### Embodiment 1

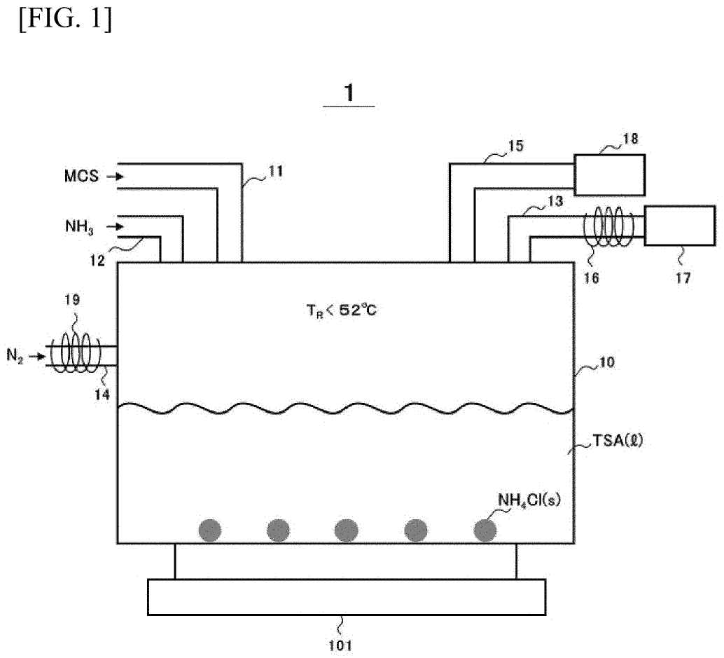

FIG. 1 is a schematic view illustrating a preparation apparatus 1 according to Embodiment 1 of the present invention. Hereinafter, the preparation apparatus 1 and the preparation method according to Embodiment 1 of the present disclosure will be described on the presumptions that monochlorosilane and ammonia are used as reactants to produce trisilylamine as a reaction product and ammonium chloride as a reaction by-product, but the present invention is not limited thereto. For example, as one of the reactants, monofluorosilane, monobromosilane, or monoiodosilane may be used instead of monochlorosilane, and depending on which reactant is used, other ammonium halide may be produced as a reaction by-product.

The preparation apparatus 1 according to Embodiment 1 of the present invention includes a reactor 10 in which a synthetic reaction of trisilylamine occurs, reactant supply pipes 11 and 12 for supplying reactants to the reactor 10, a trisilylamine discharge pipe 13 for discharging trisilylamine to the outside of the reactor 10, reactor heating means 14 and 19 for heating the reaction space of the reactor 10, and a gaseous by-product discharge pipe 15 for discharging the gaseous by-products produced by pyrolysis of the reaction by-product (e.g., ammonium chloride) using the reactor heating means 14 and 19, to the outside of the reactor 10.

Here, as shown in FIG. 1, the reactor heating means includes an inert gas supply pipe 14 for supplying an inert gas to the reactor 10, and an inert gas supply pipe heating means 19 for heating the inert gas supply pipe 14. However, the present invention is not limited thereto, and the reactor heating means may heat the wall of the reactor 10 to heat the reaction space in the reactor 10.

The reactor 10 according to Embodiment 1 of the present invention is a batch reactor in which a predetermined amount of reactants such as monochlorosilane and ammonia are supplied through the reactant supply pipes 11 and 12. Here, the monochlorosilane supply pipe 11 and the ammonia supply pipe 12 connect a monochlorosilane source (not shown) and an ammonia supply source (not shown) separately to the reactor 10. That is, monochlorosilane and ammonia are separately supplied to the reactor 10 so that the reaction does not occur before being introduced into the reactor 10. Accordingly, it is possible to prevent the reactant supply pipes 11, 12 from being clogged by the solid reaction by-product (e.g., ammonium chloride).

However, the present invention is not limited thereto, and the reactants may be supplied to the reactor in a state in which monochlorosilane and ammonia are mixed. In this case, in order to prevent the reactant supply pipe from being clogged by the reaction between monochlorosilane and ammonia, it is preferable to heat the reactant supply pipes 11, 12 and/or the mixer (not shown) to a temperature equal to or higher than the decomposition temperature of ammonium chloride.

When a predetermined amount of reactants are introduced into the reactor 10, the reactant supply pipes 11 and 12 are closed by a valve (not shown).

The reaction conditions in the reactor 10 in Embodiment 1 of the present invention are set so that (i) trisilylamine as a reaction product is in a liquid state, and (ii) ammonium chloride as a reaction by-product is in a solid state.

For example, when the pressure condition in the reactor 10 is at atmospheric pressure, the temperature T_{R} in the reactor 10 during the synthesis reaction of trisilylamine is maintained at a temperature lower than 52° C. which is the boiling point of trisilylamine (T_{R}<52° C.). Since the equilibrium phase of ammonium chloride is solid under the temperature T_{R} condition lower than 52° C., the synthesis reaction in the reactor 10 proceeds according to the following reaction scheme in Embodiment 1 of the present invention.

3SiH₃Cl+4NH₃→N(SiH₃)₃(l)+3NH₄Cl(s)

When the synthesis reaction of trisilylamine is terminated, as shown in FIG. 1, ammonium chloride in a solid state is immersed in liquid trisilylamine in the reactor 10.

In Embodiment 1 of the present invention, when the synthesis reaction of trisilylamine is terminated, the temperature inside the reactor 10 is heated to a temperature equal to or higher than 52° C., which is the boiling point of trisilylamine, in order to separate and discharge trisilylamine. For example, the inert gas heated to a temperature of 52° C. or higher by the inert gas supply pipe heating means 19 is introduced into the reactor 10 through the inert gas supply pipe 14, thereby increasing the temperature in the reactor 10. Accordingly, the phase of trisilylamine, which was a liquid state immediately after the completion of the reaction, is changed to a gaseous state.

Here, the inert gas supplied by the inert gas supply pipe 14 may be nitrogen or argon, and more preferably nitrogen. However, the present invention is not limited thereto, and the inert gas may be other gas (for example, helium, etc.) that does not react with trisilylamine or the like.

Meanwhile, in the step of heating for the separation and discharge of trisilylamine, the temperature in the reactor 10 is set to be lower than the decomposition temperature of ammonium chloride, which is a reaction by-product. As described below, since ammonium chloride is started to be thermally decomposed at a temperature around 340° (C, the temperature inside the reactor 10 is preferably set to be, for example, in a range of 52° C.≤T<340° C. in the heating step for the separation and discharge of trisilylamine. More preferably, the temperature in the reactor 10 is set to satisfy 52° C.≤T≤300° C.

Accordingly, trisilylamine as a reaction product is vaporized to fill the inner space of the reactor 10, and solid ammonium chloride as a reaction by-product is accumulated in the lower bottom of the reactor 10 or attached to the sidewall. That is, the reaction product and the reaction by-product are separated from each other in a gas phase and a solid phase, respectively.

In this state, a valve (not shown) of the trisilylamine discharge pipe 13 is opened to discharge trisilylamine in a gaseous state to the outside of the reactor 10. However, the present invention is not limited thereto, and the timing for opening the valve of the trisilylamine discharge pipe 13 may be any time after the heated inert gas is introduced into the reactor 10 for the separation and discharge of trisilylamine.

Although not shown in FIG. 1, in order to prevent the fine ammonium chloride solid particles in the reactor 10 from being discharged together with gaseous trisilylamine, a filter may be additionally installed to the inlet of the trisilylamine discharge pipe 13. The filter may be a glass frit, a metal frit, a gas permeable membrane, or the like, but may be formed of other material that does not react with trisilylamine or the like.

Trisilylamine discharged to the outside is collected using a collecting means, such as a condensation trap, as described below.

In Embodiment 1 of the present invention, it has been described that liquid trisilylamine as a reaction product is vaporized and discharged, but the present invention is not limited thereto. Because, when the synthesis reaction is completed, liquidous trisilylamine is already phase-separated from solid ammonium chloride, trisilylamine in a liquid phase may be directly discharged without being heated, or some of liquid trisilylamine may be first discharged, and then trisilylamine remaining on the bottom of the reactor may be discharged as a gas phase by heating. In this case, it is preferable that the trisilylamine discharge pipe 13 is installed at an appropriate position capable of discharging liquid trisilylamine. In addition, a pipe for discharging liquid trisilylamine and a pipe for discharging gaseous trisilylamine may be separately provided.

When trisilylamine is sufficiently separated and discharged from the reactor 10, the valve of the trisilylamine discharge pipe 13 is closed, and the temperature in the reactor 10 is increased to a temperature equal to or higher than the decomposition temperature of the reaction by-product. For example, through the inert gas supply pipe 14, an inert gas (such as nitrogen) heated to a temperature equal to or higher than the decomposition temperature of ammonium chloride using the inert gas supply pipe heating means 19 is supplied into the reactor 10. The temperature of the inert gas supplied for the pyrolysis of the reaction by-product is, set, for example, at a temperature of 340° C. or higher.

In the present invention, the decomposition temperature of the reaction by-product, such as ammonium chloride, refers to the temperature at which ammonium chloride is decomposed into gaseous substances such as ammonia and hydrogen chloride. According to the experiment of the inventors of the present invention, ammonium chloride is hardly pyrolyzed at a temperature of 300° C. and meaningful pyrolysis starts at 340° C.

It is preferable, thus, that the temperature of the inert gas supplied for the pyrolysis of the reaction by-product is 350° C. or higher, more preferably 400° C. or higher, and even more preferably 450° C. or higher so that the pyrolysis of ammonium chloride can occur quickly. According to the experiment of the inventors of the present invention, when the temperature of the supplied inert gas is 350° C., a thermal decomposition of about 75% by the weight of the reaction by-product occurred within 1 hour, a thermal decomposition of about 80% occurred at 400° C., and when the temperature was about 450° C., 90% or more of ammonium chloride was decomposed to gaseous substances. When the thermal decomposition is performed at a temperature higher than 450° C., the pyrolysis rate may further increase, and the pyrolysis time may be shortened, but the temperature of the inert gas supplied for the pyrolysis of the reaction by-product is set preferably to 520° C. or less in terms of the balance between the thermal decomposition efficiency and energy consumption.

As such, by heating the space inside the reactor 10 to a temperature equal to or higher than the decomposition temperature of ammonium chloride, the solid ammonium chloride remaining in the reactor 10 is decomposed into gaseous ammonia and hydrogen chloride. By this heating, silane, silazane, and trace amount of trisilylamine, which were smeared on ammonium chloride solid particles, become also gaseous.

When the thermal decomposition of ammonium chloride proceeds sufficiently, a valve (not shown) of the gaseous by-product discharge pipe 15 is opened to discharge gaseous by-products such as ammonia, hydrogen chloride, silane, silazane, and trace amount of trisilylamine from the reactor 10. As described below, the discharged gaseous by-products are removed, for example, through a scrubber (gaseous by-product processing means).

Once the gaseous by-products are sufficiently discharged, an inert gas (e.g., nitrogen, etc.) is supplied to the reactor 10 to purge the reaction space in the reactor 10. It is preferred that the temperature of the inert gas for purging is less than 52° C. i.e., the reaction temperature T_{R} for the next batch of the synthesis reaction.

When the purge by the inert gas is terminated, the valves of the reactant supply pipes 11 and 12 are opened again to perform a synthesis reaction of a next batch. Thereafter, the above-described process is repeated.

The preparation apparatus 1 according to Embodiment 1 of the present invention further includes, as trisilylamine collecting means for collecting gaseous trisilylamine discharged to the outside of the reactor 10, a condenser 16 and a trisilylamine collecting container 17 for containing condensed trisilylamine.

The trisilylamine collecting container 17 includes a dry ice/isopropyl alcohol cooling bath maintained at a temperature from about 20° C. to about −110° (C, preferably from about −50° C. to about −110° C. However, the present invention is not limited thereto, and other collecting means capable of collecting trisilylamine discharged in a gas phase may be used.

The preparation apparatus 1 according to Embodiment 1 of the present invention may further includes a scrubber 18 as a means for removing ammonia, hydrogen chloride, silane, silazane, and the like, which are produced by pyrolysis of ammonium chloride and discharged in a gas phase. The scrubber 18 of the present invention may be one that are commonly used in the art.

In Embodiment 1 of the present invention, after the above-described batch process has progressed over several times (after a large amount of ammonium chloride solid particles are accumulated on the reactor floor enough to be removed), the operation of the reactor 10 is stopped, and the unpyrolyzed solid ammonium chloride accumulated in the reactor 10 is removed. To this end, the preparation apparatus according to Embodiment 1 of the present invention may further include a solid-phase reaction by-product collection container 101 for collecting and accommodating ammonium chloride in the form of solid particles. The solid-phase reaction by-product collection container 101 for collecting solid ammonium chloride is connected to the bottom of the reactor 10, for example, through a gate valve (not shown).

The gate valve is closed during the operation of the reactor 10, and the ammonium chloride solid particles accumulated in the lower portion of the reactor 10 are discharged to the solid-phase reaction by-product collection container 101 after a predetermined number of batch processes are completed or between the batch processes. When the solid-phase reaction by-product collection container 101 is filled with solid ammonium chloride particles, the solid ammonium chloride particles are removed by discharging the solid ammonium chloride particles from the solid phase reaction by-product collection container 101 to the outside.

The solid ammonium chloride particles collected in the solid-phase reaction by-product collection container 101 were subjected to at least one pyrolysis process using a high-temperature inert gas, and, thus, silane, silazane, and trace trisilylamine, which are other by-products smeared on the surface of solid ammonium chloride particles immediately after the synthesis reaction, may be safely removed by the scrubber 18 through the above-described pyrolysis/gaseous by-products discharge process. Therefore, although the solid ammonium chloride particles are exposed to the atmosphere in the process of discharging the solid ammonium chloride particles from the solid-phase reaction by-product collection container 101, the possibility of spontaneous ignition may be greatly reduced since the flammable substance does not substantially remain on the surface of the solid particles of ammonium chloride.

While the solid ammonium chloride particles are discharged from the collection container 101, a cleaning operation of the reactor 10 such as removing ammonium chloride which is not accumulated on the bottom of the reactor 10 and attached to the sidewall or a filter (not shown) of the reactor 10, may be performed together.

Although the configuration of the reactor having a single reaction vessel has been described above, the present invention is not limited thereto, and the reactor may include a plurality of reaction vessels. That is, the reactor 10 of the present invention may include a plurality of reaction vessels which are connected in parallel to supply sources of reactants and can be simultaneously or alternately operated. The plurality of reaction vessels may be operated to perform a synthesis reaction of trisilylamine in at least one reaction vessel while a pyrolysis process of the reaction by-product and/or a discharge process of the pyrolyzed gaseous by-products is performed in at least one other reaction vessel.

For example, the reactor 10 may include a first reaction vessel and a second reaction vessel, and during the synthesis reaction of trisilylamine in the first reaction vessel, the second reaction vessel may be operated to perform pyrolysis of the reaction by-product and/or discharge of thermally decomposed gaseous by-products.

Accordingly, the decrease of the throughput of the overall preparation apparatus due to the thermal decomposition process of the reaction by-product performed between a synthesis process and a next synthesis process may be suppressed.

According to Embodiment 1 of the present invention, since the solid ammonium chloride particles in the reactor 10 is pyrolyzed and removed together with other gaseous by-products (silane, silazane, trace amounts of trisilylamine, etc.), it is possible to prevent clogging of the pipes or the like by solid ammonium chloride particles and to reduce the decrease of the yield of trisilylamine, and the risk of spontaneous ignition can be reduced by inhibiting the exposure of spontaneous combustible materials such as silane or silazane to the atmosphere.

### Embodiment 2

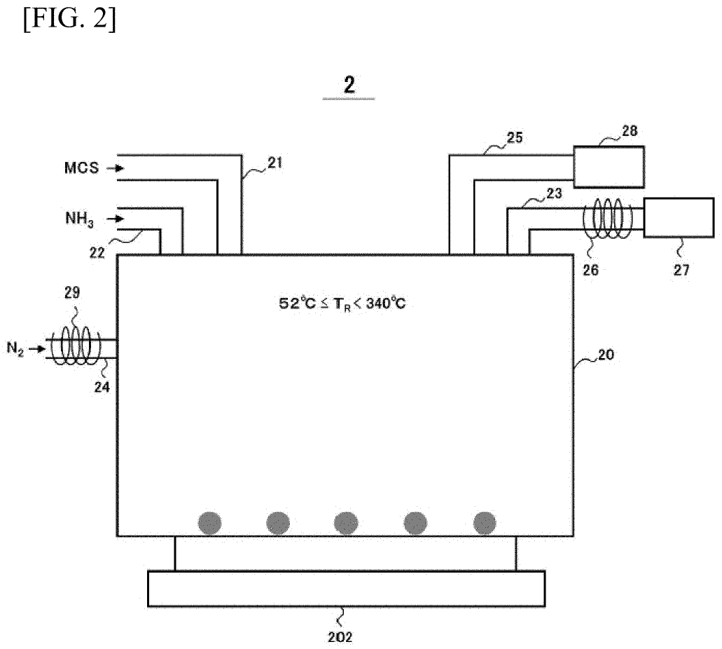

FIG. 2 is a schematic view illustrating a preparation apparatus 2 and a preparation method according to Embodiment 2 of the present invention. Embodiment 2 of the present invention is different from Embodiment 1 of the present invention in that during the synthesis reaction process in the reactor 20, the temperature in the reactor 20 is maintained at a temperature equal to or higher than the boiling point of the trisilylamine which is the reaction product, and that the synthesis reaction is continuously or semi-continuously performed.

Hereinafter, Embodiment 2 of the present invention will be described in detail, mainly on the difference from Embodiment 1.

In Embodiment 2 of the present invention, the reactor 20 is operated under atmospheric pressure and continuously receives monochlorosilane and ammonia, which are reactants, through the reactant supply pipes 21 and 22 during the synthesis reaction process. That is, the reactor 20 of Embodiment 2 is a continuous or semi-continuous reactor.

During the synthesis reaction process of trisilylamine, the reaction space of the reactor 20 is maintained at a temperature equal to or higher than the boiling point of trisilylamine which is the reaction product and is maintained at a temperature lower than the decomposition temperature of ammonium chloride among the reaction by-products. For example, the reaction space in the reactor 20 is heated to satisfy 52° C.≤T_{R}≤340° C. during the synthesis reaction process. More preferably, the temperature inside the reactor 20 is 52° C.≤T_{R}≤300° C.

That is, the synthesis reaction of Embodiment 2 proceeds according to the following reaction scheme.

3SiH₃Cl+4NH₃→N(SiH₃)₃(g)+3NH₄Cl(s)

To this end, for example, during the synthesis reaction process, an inert gas (e.g., nitrogen, etc.) heated by the inert gas supply piping heating means 29 is fed into the reactor 20 through the inert gas supply pipe 24 to satisfy the above temperature conditions. However, the present invention is not limited thereto, and the temperature of the reaction space in the reactor 20 may be adjusted by heating the wall of the reactor 20.

As the synthesis reaction proceeds, trisilylamine in a gas phase is produced, and the produced gaseous trisilylamine is continuously discharged from the reactor 20 through the trisilylamine discharge pipe 23. Although FIG. 2 illustrates that the reactant supply pipes 21 and 22 and the trisilylamine discharge pipe 23 are connected to the upper portion of the reactor 20, the present invention is not limited thereto, and, so long as the supply of the reactants from the reactant supply pipes 21 and 22 and discharge of trisilylamine through the trisilylamine discharge pipe 23 may be performed smoothly, they may have a different arrangement. Although not shown in FIG. 2, in order to prevent the fine ammonium chloride solid particles from being discharged together with trisilylamine, the inlet of the trisilylamine discharge pipe 23 may be provided with a filter or the like.

Gaseous trisilylamine discharged from the reactor 20 is condensed in the condenser 26 and collected in the trisilylamine collection container 27. The trisilylamine collection vessel 27 may include, for example, a dry ice/isopropyl alcohol cooling bath maintained at a temperature lower than the boiling point of trisilylamine, such as from about 20° C. to about −110° C., preferably from about −50° C. to about −110° C.

As the synthesis reaction proceeds, solid ammonium chloride is accumulated in the reactor 20 as a reaction by-product.

After the synthesis reaction has progressed for a predetermined time, the supply of the reactants and the discharge of trisilylamine are stopped and then an inert gas (e.g., nitrogen) heated to a temperature equal to or higher than the decomposition temperature of ammonium chloride by the inert gas supply pipe heating means 29 is supplied through the inert gas supply pipe 23 in order to remove the solid ammonium chloride accumulated in the reactor 20 by pyrolysis.

The temperature of the inert gas (e.g., nitrogen) supplied for the pyrolysis of ammonium chloride is not less than 340° C., preferably not less than 350° C., more preferably not less than 400° C. and even more preferably not less than 450° C. However, it is preferable that the temperature is 520° C. or less for balance with energy consumption.

As the inert gas heated to a temperature equal to or higher than the decomposition temperature of ammonium chloride is supplied into the reactor 20, the solid ammonium chloride particles remaining in the reactor 20 are decomposed into gaseous ammonia and hydrogen chloride, and silane, silazane, and a trace amount of trisilylamine smeared on the solid ammonium chloride particles become gaseous.

While the thermal decomposition of ammonium chloride is sufficiently progressed, the valve of the gaseous by-product discharge pipe 25 of the reactor 20 is opened to discharge gaseous by-products such as ammonia, hydrogen chloride and silane from the reactor 20, and the remove process by the scrubber 28 are performed.

According to Embodiment 2, the solid ammonium chloride particles in the reactor 20 are thermally decomposed and removed by a high-temperature inert gas, thereby preventing solid ammonium chloride particles from clogging a pipe or reducing the yield of trisilylamine, and furthermore, other combustible by-products smeared on solid ammonium chloride particles may also be safely removed.

When the discharge and the removal of the gaseous by-products are completed, an inert gas (e.g., nitrogen) is supplied into the reactor 20 and purging is performed. The inert gas used in the purge is preferably at a temperature equal to the temperature T_{R} of the synthesis reaction, that is, equal to or greater than 52° C. and less than 340° C. More preferably, the temperature is greater than or equal to 52° C. and less than or equal to 300° C.

In order to remove solid ammonium chloride remaining in the reactor 20 without being pyrolyzed, the preparation apparatus 2 of Embodiment 2 may further include a solid-phase reaction by-product collection container 202 connected to the lower portion of the reactor 20 through a gate valve (not shown) and a gate valve for opening and closing the solid-phase reaction by-product collection container 202. As described above, since combustible substance is substantially completely removed from the surface of the solid ammonium chloride particles subjected to the pyrolysis process, even if the solid ammonium chloride particles are exposed to atmosphere during the process of discharging them from the solid-phase reaction by-product collection container 202, the risk of spontaneous ignition is significantly lowered.

Although it has been described herein that the reactor 10 or the reactor 20 is operated under atmospheric pressure, the present invention is not limited thereto, and the reactor 10 or the reactor 20 may be operated under a reduced pressure condition. When the reactor 10 or the reactor 20 is operated in the reduced pressure condition, the temperature in the reactor may be appropriately changed within the technical spirit of the present invention.

1. A trisilylamine preparation apparatus comprising:
a reactor in which a trisilylamine synthesis reaction occurs;
reactant supply pipes for supplying reactants to the reactor;
a trisilylamine discharge pipe for discharging trisilylamine from the reactor;
a reactor heating means for heating reaction space of the reactor; and
a gaseous by-product discharge pipe for discharging gaseous by-products from the reactor,
wherein the reaction space of the reactor is maintained at a temperature that is lower than the decomposition temperature of a reaction by-product produced during the synthesis reaction,
wherein the reactor heating means heats the reaction space of the reactor to a temperature that is equal to or higher than the decomposition temperature after trisilylamine is discharged through the trisilylamine discharge pipe, and
wherein the gaseous by-product discharge pipe discharges the gaseous by-products containing a pyrolysate of the reaction by-product, which is produced through pyrolysis by means of the reactor heating means.

2. The trisilylamine preparation apparatus of claim 1, wherein the reactor heating means comprises an inert gas supply pipe for supplying an inert gas to the reaction space of the reactor, and an inert gas supply pipe heating means for heating the inert gas supply pipe.

3. The trisilylamine preparation apparatus of claim 2, wherein the inert gas is nitrogen.

4. The trisilylamine preparation apparatus of claim 1, further comprising a scrubber connected to the gaseous by-product discharge pipe and treating the gaseous by-products.

5. The trisilylamine preparation apparatus of claim 1, further comprising a condenser which is connected to the trisilylamine discharge pipe and condenses gaseous trisilylamine, and a trisilylamine collection container for collecting condensed trisilylamine.

6. The trisilylamine preparation apparatus of claim 1, wherein the reactor comprises a plurality of reaction vessels that are connected in parallel to sources of reactants and can be simultaneously or alternately operated.

7. The trisilylamine preparation apparatus of claim 6, wherein the reactor comprises a first reaction vessel and a second reaction vessel, and wherein the reaction space of at least the second reaction vessel is heated to a temperature equal to or higher than the decomposition temperature while the reaction in the first reaction vessel is in progress.

8. The trisilylamine preparation apparatus of claim 1, wherein the reactant supply pipes include a supply pipe of monochlorosilane and a supply pipe of ammonia, and the supply pipe of monochlorosilane and the supply pipe of ammonia are respectively and independently connected to the reactor.

9. The trisilylamine preparation apparatus of claim 1, further comprising a solid-phase reaction by-product collection container connected to the reactor to collect the solid-phase reaction by-product, and a gate valve configured to be opened and closed between the solid-phase reaction by-product collection container and the reactor.

10. The trisilylamine preparation apparatus of claim 1, wherein the reactor is a batch reactor.

11. The trisilylamine preparation apparatus of claim 1, wherein the reactor is a continuous reactor.

12. A method for preparing trisilylamine comprising the steps of:
introducing reactants into a reactor;
reacting the introduced reactants to produce trisilylamine and a reaction by-product;
discharging trisilylamine from the reactor;
pyrolyzing the reaction by-product in the reactor after discharging trisilylamine; and
discharging gaseous by-products produced in the step of pyrolyzing the reaction by-product from the reactor,
wherein, in the step of reacting, the temperature in the reactor is maintained at a temperature lower than the decomposition temperature of the reaction by-product, and
wherein the step of pyrolyzing the reaction by-product comprises a step of heating the reaction space of the reactor to a temperature equal to or higher than the decomposition temperature of the reaction by-product.

13. The method of claim 12, wherein the step of pyrolyzing the reaction by-product comprises introducing to the reactor an inert gas heated to a temperature equal to or higher than the decomposition temperature of the reaction by-product.

14. The method of claim 13, wherein the inert gas comprises nitrogen.

15. The method of claim 13, further comprising treating the discharged gaseous by-products.

16. The method of claim 15, wherein the treating comprises removing the gaseous by-products by a scrubber.

17. The method of claim 13, wherein during the step of reacting, the reactor is maintained at a temperature lower than the boiling point of trisilylamine.

18. The method of claim 17, further comprising heating the reaction space of the reactor to a temperature equal to or higher than a boiling point of trisilylamine before the step of discharging trisilylamine and after the completion of the step of reacting.

19. The method of claim 17, wherein the step of reacting is performed in a batch manner.

20. The method of claim 13, wherein during the step of reacting, the reactor is maintained at a temperature equal to or higher than the boiling point of trisilylamine.

21. The method of claim 20, wherein the step of reacting is performed in a continuous or semi-continuous manner.

22. The method of claim 17, further comprising condensing and collecting gaseous trisilylamine.

23. The method of claim 12, further comprising discharging a solid reaction by-product which is accumulated in the reactor and is not pyrolyzed in the step of pyrolyzing, from the reactor.

24. The method of claim 12, wherein the reactants include monochlorosilane and ammonia, and the reaction by-product includes ammonium chloride.
